(19) United States
(12) Patent Application Publication
(10) Pub. No.: US 2017/0124027 A1
(43) Pub. Date: May 4, 2017

(54) METHOD AND SYSTEM FOR GENERATING AN EMBEDDING PATTERN USED FOR SOLVING A QUADRATIC BINARY OPTIMIZATION PROBLEM

(71) Applicant: 1QB INFORMATION TECHNOLOGIES INC., Vancouver (CA)

(72) Inventors: Arman ZARIBAFIYAN, Vancouver (CA); Dominic MARCHAND, Vancouver (CA); Seyed Saeed CHANGIZ REZAEI, Vancouver (CA)

(21) Appl. No.: 15/344,054

(22) Filed: Nov. 4, 2016

Related U.S. Application Data
(60) Provisional application No. 62/250,705, filed on Nov. 4, 2015.

(51) Int. Cl. G06F 17/11; G06N 5/04

(52) U.S. Cl. CPC G06F 17/11; G06N 5/047

(57) ABSTRACT

A method and system are disclosed for generating an embedding pattern used for solving a quadratic binary optimization problem using a quadratic solver characterized by an architecture. The method comprises obtaining an indication of a quadratic binary optimization problem; decomposing the quadratic binary optimization problem into a product of graphs representative of the input problem; selecting a graph of the product of graphs representative of the quadratic binary optimization problem; determining a nexus for embedding the selected graph of the product of graphs representative of the input problem in the architecture of the quadratic solver; determining a corresponding pattern for the nexus and buses to generate an embedding pattern and providing an indication of the embedding pattern.

### CROSS-REFERENCE TO RELATED APPLICATION

This application claims the benefit of U.S. Provisional Patent Application No. 62/250,705 entitled “Method and system for generating an embedding pattern used for solving a quadratic binary optimization problem,” filed Nov. 4, 2015, the specification of which is hereby incorporated by reference.

### FIELD OF THE INVENTION

The invention relates to computers. More precisely, the invention pertains to a method and system for generating an embedding pattern used for solving a quadratic binary optimization problem.

### BACKGROUND OF THE INVENTION

The majority of the interesting combinatorial optimization problems are hard to solve; graph similarity, graph partitioning, graph coloring, resource allocation problems, and scheduling problems are among those combinatorial optimization problems proven to be NP-hard.

Some of these problems have significant real-world applications, which make them especially interesting.

For example, graph similarity is a challenging problem when comparing the structure of different molecules and of great importance in drug design applications.

Many of these problems can be formulated as a quadratic binary optimization problem suitable for enabling the use of quadratic solvers to find efficient solutions for these problems. The quadratic solver developed by D-Wave Systems can be considered one embodiment of such a quadratic binary optimization solver (see W. M. Kaminsky and S. Lloyd, Quantum Computing and Quantum Bits in Mesoscopic Systems, Springer, 229-236 (2004)).

A quadratic binary optimization problem is conveniently described as a graph G=(V,E) comprising a set of nodes V and adjacency relations between them represented by edges E. Two nodes are adjacent if and only if they are connected by an edge. A mapping of one graph to another graph is called an embedding. Minor-graph embedding is a specific type of mapping which further allows adjacent nodes of the second graph to be contracted into larger effective nodes, called chains. The resulting mapping can have one node assigned to a set of connected nodes in the second graph. A detailed description of graph embedding is disclosed in “Minor-embedding in adiabatic quantum computation: II. Minor-universal graph design,” V. Choi, Quantum Information Processing 10, 343 (2010).

Solving a quadratic binary optimization problem using a quadratic binary optimization solver typically requires representing the given quadratic binary optimization problem, and the quadratic binary optimization solver architecture, with two suitable graphs. The graph representing the given quadratic binary optimization problem is referred to as the input graph and the graph representing the quadratic binary optimization solver architecture is referred to as the target graph. In the process of solving the given quadratic binary optimization problem using the quadratic binary optimization solver, the input graph is embedded into the target graph. This means that the input graph is mapped to the target graph.

In general, minor-graph embedding itself is an NP-hard problem; as the size of the graphs increases, the general problem of finding an embedding can become very computationally expensive.

As a result, the most widely used embedding algorithms are heuristic in nature, sacrificing embedding quality with respect to chain length, number of qubits, etc., and success probability in order to achieve polynomial running times.

Even then, finding an embedding is typically very time-consuming which is cumbersome.

There is a need for a method and a system that will overcome at least one of the above-identified drawbacks.

Features of the invention will be apparent from review of the disclosure, drawings and description of the invention below.

### BRIEF SUMMARY OF THE INVENTION

According to a broad aspect, there is disclosed a method for generating an embedding pattern used for solving a quadratic binary optimization problem using a quadratic solver characterized by an architecture comprising a plurality of blocks, each block comprising a plurality of registers, the method comprising use of a processing device for: obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem; decomposing the quadratic binary optimization problem into a product of graphs representative of the input problem; selecting a graph of the product of graphs representative of the quadratic binary optimization problem, the selected graph having corresponding selected graph variables; the other graph having a plurality of edges; determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus; determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph and providing an indication of the embedding pattern.

In accordance with an embodiment, the indication of a quadratic binary optimization problem is obtained from one of a user interacting with the processing device, a memory located in the processing device and a remote processing device operatively connected to the processing device.

In accordance with an embodiment, the decomposing of the quadratic binary optimization problem into a product of graphs representative of the input problem quadratic binary optimization problem comprises determining a first graph G₁ and a second graph G₂ such that the graph G is a spanning subgraph of G₁□G₂.

In accordance with an embodiment, the selecting of a graph of the product of graphs representative of the quadratic binary optimization problem comprises determining graphs H₁ and H₂ such that the determined graphs H₁ and H₂ contain G₁ and G₂ as spanning subgraphs respectively; further wherein the graph selected is one of the determined graphs H₁ and H₂.

In accordance with an embodiment, the graph is selected based on at least one parameter selected from a group consisting of a size of the determined graphs H₁ and H₂, a density of the determined graphs H₁ and H₂, and adjacency properties of the architecture characterizing the quadratic solver.

In accordance with an embodiment, the indication of the embedding pattern is provided to a user interacting with the processing device.

In accordance with an embodiment, the providing of the indication of the embedding pattern comprises performing at least one of storing the indication of the embedding pattern in a memory located in the processing device and providing the indication of the embedding pattern to a remote processing device operatively connected to the processing device.

In accordance with an embodiment, the embedding pattern is provided to the quadratic solver.

In accordance with an embodiment, the method further comprises obtaining an indication of at least one inoperable component in the architecture of the quadratic solver and performing at least one of removing the at least one inoperable component from the embedding pattern to produce a smaller valid embedding pattern; rerouting at least one connecting bus around the at least one inoperable component; modifying each nexus instance to avoid the at least one inoperable component; selecting a nexus embedding for each instances while preserving the same interface to avoid the at least one inoperable components and permuting an assignment of variable on each nexus instance to avoid the at least one inoperable component.

According to a broad aspect, there is disclosed a method for solving a quadratic binary optimization problem using a quadratic solver, the method comprising generating an embedding pattern used for solving the quadratic binary optimization problem using the quadratic solver according to the method disclosed herein and solving the quadratic binary optimization problem using the embedding pattern generated.

According to a broad aspect, there is disclosed a processing device for generating an embedding pattern used for solving a quadratic binary optimization problem using a quadratic solver, the processing device comprising a central processing unit; a display device; a communication port for operatively connecting the processing device to a quadratic solver characterized by an architecture comprising a plurality of blocks, each block comprising a plurality of registers; a memory unit comprising an application for generating an embedding pattern used for solving a quadratic binary optimization problem, the application comprising instructions for obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem; instructions for decomposing the quadratic binary optimization problem into a product of graphs representative of the input problem; instructions for selecting a graph of the product of graphs representative of the quadratic binary optimization problem, the selected graph having corresponding selected graph variables; the other graph having a plurality of edges; instructions for determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus; instructions for determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph; instructions for providing an indication of the embedding pattern and a data bus for interconnecting the central processing unit, the display device, the communication port and the memory unit.

According to a broad aspect, there is disclosed a non-transitory computer-readable storage medium for storing computer-executable instructions which, when executed, cause a processing device to perform a method for generating an embedding pattern used for solving a quadratic binary optimization problem using a quadratic solver characterized by an architecture comprising a plurality of blocks, each block comprising a plurality of registers, the method comprising obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem; decomposing the quadratic binary optimization problem into a product of graphs representative of the input problem; selecting a graph of the product of graphs representative of the quadratic binary optimization problem, the selected graph having corresponding selected graph variables; the other graph having a plurality of edges; determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus; determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph and providing an indication of the embedding pattern.

According to a broad aspect, there is disclosed a method for generating an embedding pattern used for solving a quadratic binary optimization problem using a quadratic solver characterized by an architecture comprising a plurality of blocks, each block comprising a plurality of registers, the method comprising obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem; decomposing the quadratic binary optimization problem into a product of graphs representative of the input problem; selecting a graph of the product of graphs representative of the quadratic binary optimization problem, the selected graph having corresponding selected graph variables; the other graph having a plurality of edges; determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus; determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph and providing an indication of the embedding pattern.

According to a broad aspect, there is disclosed a method for generating an embedding pattern used for solving a quadratic binary optimization problem using a quadratic solver characterized by an architecture, the method comprising obtaining an indication of a quadratic binary optimization problem representative of an input problem to solve using the quadratic solver; decomposing the quadratic binary optimization problem into a product of graphs representative of the input problem; selecting a graph of the product of graphs representative of the quadratic binary optimization problem; determining a nexus for embedding the selected graph of the product of graphs representative of the input problem in the architecture of the quadratic solver; determining a corresponding pattern for the nexus and buses to generate an embedding pattern using another graph of the product of graphs; and providing an indication of the embedding pattern.

In accordance with an embodiment, the quadratic binary optimization problem is decomposed into a product of more than two graphs representative of the input problem; the graph selected is comprised of one selected graph or a product of more than one selected graph of the product of more than two graphs; further wherein the other graph used for determining the pattern of more than one of the determined nexus and corresponding connecting buses is comprised of a non-selected graph or a product of all the more than one non-selected graphs of the product of more than two graphs.

An advantage of the method for generating an embedding pattern disclosed herein is that it improves the solving of graph optimization problems on quadratic solvers having a lattice-like structure. In particular, an advantage of the method for generating an embedding pattern disclosed herein is that fewer registers qubits may be required to solve the optimization problem on the quadratic solver.

Another advantage of the method for generating an embedding pattern disclosed herein is that a better distribution of chain lengths may also be achieved.

Another advantage of the method for generating an embedding pattern disclosed herein is that larger problems may also be embedded in a faster embedding time.

Another advantage of the method for generating an embedding pattern disclosed herein that a higher success rate may be obtained compared to prior art available heuristic methods for generating an embedding pattern.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for generating an embedding pattern used for solving a quadratic binary optimization problem using a quadratic solver.

FIG. 2 is a flowchart which shows an embodiment for selecting a graph.

FIG. 3 is a flowchart which shows an embodiment for determining a nexus for embedding the selected graph and for determining a corresponding pattern for the nexus and buses.

FIG. 4 is a flowchart which shows an embodiment for providing an indication of the embedding pattern.

FIG. 5a is a diagram which shows an embodiment of a block in a 2D lattice of blocks with the block terminals and interfaces.

FIG. 5b is a diagram which shows an embodiment of a nexus with its terminal and interfaces.

FIG. 6 is a diagram which shows an embodiment of a 2D lattice of blocks in which three instances of a given nexus are embedded.

FIG. 7 is a block diagram which shows an embodiment of a processing device in which the method for generating an embedding pattern used for solving a quadratic binary optimization problem using a quadratic binary optimization solver may be implemented.

FIG. 8 is a flowchart which shows an embodiment for providing an indication of the embedding pattern when the target architecture has inoperable components.

FIG. 9 is a flowchart which shows an embodiment for providing an indication of the embedding pattern based on a previous embedding pattern and a method for shifting and extending nexus instances to avoid inoperable components.

FIG. 10 is a diagram which shows an embodiment of an embedding pattern modified by shifting and extending nexus instances to avoid inoperable components.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “quadratic solver,” “quadratic binary optimization solver” and like terms mean a method, a procedure, a software system, a device or a combination of those, that can solve a quadratic binary optimization problem; whereby solving means finding the optimum or one of the optima of the quadratic binary polynomial representative of the problem; further whereby a quadratic binary polynomial is a polynomial of binary variables and terms are at most quadratic in these variables.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method for generating an embedding pattern for solving a quadratic binary optimization problem, a system for generating an embedding pattern for solving a quadratic binary optimization problem and its use for solving the quadratic binary optimization problem.

It will be appreciated that the method for generating an embedding pattern for solving a quadratic binary optimization problem may be implemented using a processing device, also referred to as a system.

In one embodiment, the processing device is selected from a group consisting of smartphones, laptop computers, desktop computers, servers, etc.

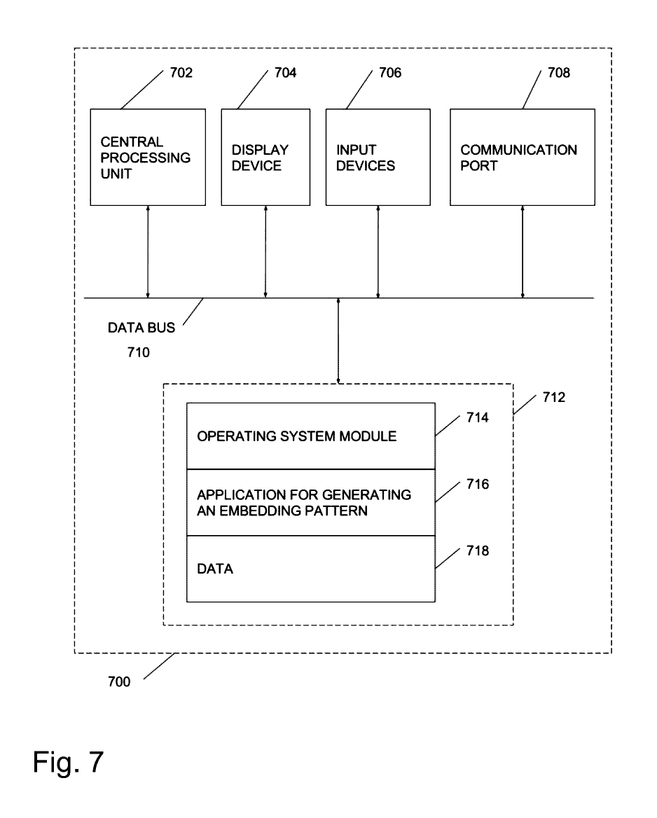

Now referring to FIG. 7, there is shown an embodiment of a processing device 700 which may be used for generating an embedding pattern used for solving a quadratic binary optimization problem using a quadratic solver.

In this embodiment, the processing device 700 comprises a central processing unit (CPU) 702, also referred to as a microprocessor, a display device 704, input devices 706, communication ports 708, a data bus 710 and a memory unit 712.

The central processing unit 702 is used for processing computer instructions. The skilled addressee will appreciate that various embodiments of the central processing unit 702 may be provided.

In one embodiment, the central processing unit 702 is a Core i5 Intel processor running at 2.5 GHz and manufactured by Intel™.

The display device 704 is used for displaying data to a user. The skilled addressee will appreciate that various types of display device may be used.

In one embodiment, the display device 704 is a standard liquid-crystal display (LCD) monitor.

The communication ports 708 are used for sharing data with the processing device 700. The communication ports 708 may also be used for enabling a connection with the quadratic solver, not shown.

The communication ports 708 may comprise for instance a universal serial bus (USB) port for connecting a keyboard and a mouse to the processing device 700.

The communication ports 708 may further comprise a data network communication port such as an IEEE 802.3 (Ethernet) port for enabling a connection of the processing device 700 with another processing device.

The skilled addressee will appreciate that various alternative embodiments of the communication ports 708 may be provided.

In one embodiment, the communication ports 708 comprise an Ethernet port and a mouse port (e.g., Logitech™).

The memory unit 712 is used for storing computer executable instructions.

It will be appreciated that the memory unit 712 comprises in one embodiment an operating system module 714.

It will be appreciated by the skilled addressee that the operating system module 714 may be of various types.

In an embodiment, the operating system module 714 is Windows™ 8 manufactured by Microsoft™.

Each of the CPU 702, the display device 704, the input devices 706, the communication ports 708 and the memory unit 712 is interconnected via the data bus 710.

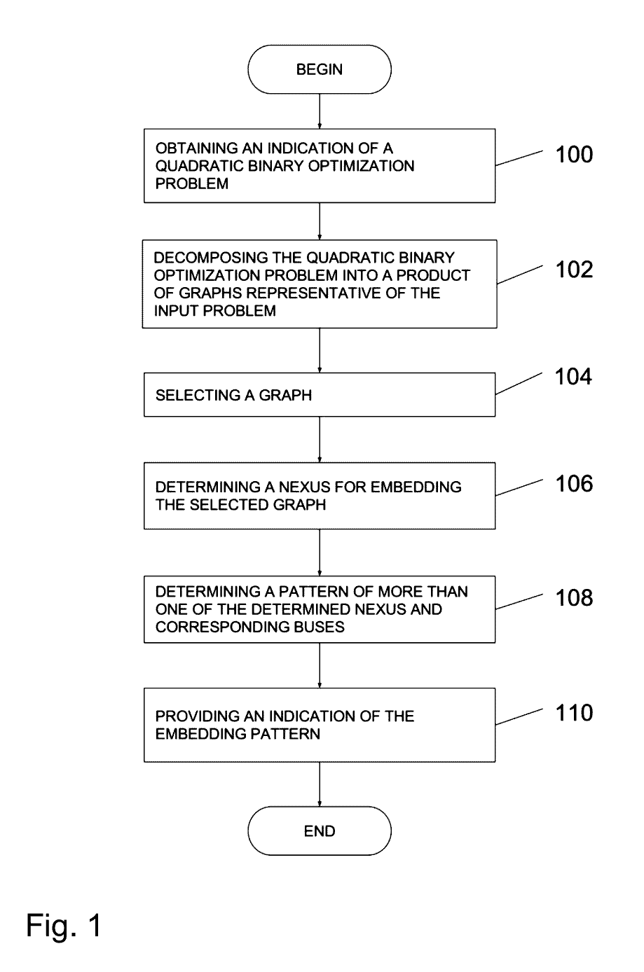

Now referring to FIG. 1 and according to processing step 100, an indication of a quadratic binary optimization problem is obtained.

It will be appreciated that the indication of a quadratic binary optimization problem is representative of a quadratic binary optimization problem to solve using the quadratic solver.

Moreover, it will be appreciated that the indication of a quadratic binary optimization problem may be obtained according to various embodiments.

In one embodiment, the indication of a quadratic binary optimization problem is obtained from a user interacting with the processing device 700.

In another embodiment, the indication of a quadratic binary optimization problem is obtained from the memory unit 712 located in the processing device 700.

In an alternative embodiment, the indication of a quadratic binary optimization problem is obtained from a remote processing device, not shown, operatively connected to the processing device 700.

The remote processing device may be operatively connected to the processing device 700 according to various embodiments. In one embodiment, the remote processing device is operatively connected to the processing device 700 via a data network. The data network may be selected from a group of at least one of a local area network (LAN), a metropolitan area network (MAN) and a wide area network (WAN). In one embodiment, the data network comprises the Internet.

Moreover, it will be appreciated that the quadratic binary optimization problem may be defined according to various embodiments.

In one embodiment, the quadratic binary optimization problem is defined as a graph. As mentioned above, the graph G=(V,E) may comprise a set of nodes V and adjacency relations between them represented by corresponding edges E. It will be appreciated that two nodes of the graph are adjacent if and only if they are connected by an edge. It will be appreciated that the set of nodes is used for representing variables of the input problem while the corresponding edges are used for representing terms of the input problem.

Still referring to FIG. 1 and according to processing step 102, the quadratic binary optimization problem is decomposed into a product of graphs representative of the input problem. In one embodiment, the product of graphs comprises a first graph G₁ and a second graph G₂.

In one embodiment, the decomposing of the quadratic binary optimization problem into a product of graphs representative of the input problem quadratic binary optimization problem comprises determining a first graph G₁ and a second graph G₂ such that the graph G is a spanning subgraph of G₁□G₂.

It will be appreciated that, in one embodiment, the quadratic binary optimization problem is decomposed into a product of graphs representative of the input problem using the processing device 700.

In fact, it will be appreciated that in one embodiment the quadratic binary optimization problem is a polynomial in m×n variables x₁₁, . . . , x₁ₙ, . . . , xₘ₁, . . . , xₘₙ with quadratic terms xᵢₖxⱼ₁ as its monomials.

The quadratic binary optimization problem may be represented by a graph G whose nodes are the variables x₁₁, . . . x₁ₙ, . . . , xₘ₁, . . . xₘₙ and whose two nodes xᵢₖ and xⱼ₁ are adjacent if there is a monomial xᵢₖxⱼ₁ in the quadratic binary optimization problem.

Let G₁ be the graph obtained by the union of the subgraphs of the input graph G induced on the vertex set {xᵢ₁, . . . , xᵢₙ} for all iε{1, . . . , m}. That is, G₁=∪_{i=1:m}G[xᵢ₁, . . . , xᵢₙ].

Similarly, let G₂ be the graph obtained by the union of the subgraphs of the input graph G induced on the vertex set {x₁ⱼ, . . . , xₘⱼ} for all jε{1, . . . , n}. That is, G₂=∪_{j=1:n}G[x₁ⱼ, . . . , xₘⱼ].

In an alternative embodiment, the product of graphs representative of the input problem comprises more than two graphs G₁, . . . , Gₙ such that the graph G is a spanning subgraph of G₁□ . . . □Gₙ.

In one embodiment, one of the n graphs is assumed to be the first graph and the product of the other graphs are assumed to be the other graph referred to in the rest of the method. In another embodiment, any commutation and association of the graphs of the product of graphs into two effective graphs is possible and the rest of the method simply uses these two effective graphs. In one embodiment, the fact that the two graphs of the method can themselves be a product of graphs allows for a possible recursive use of the method.

Still referring to FIG. 1 and according to processing step 104, a graph of the product of graphs representative of the quadratic binary optimization problem is selected.

In one embodiment, the graph of the product of graphs representative of the quadratic binary optimization problem is selected using the processing device 700.

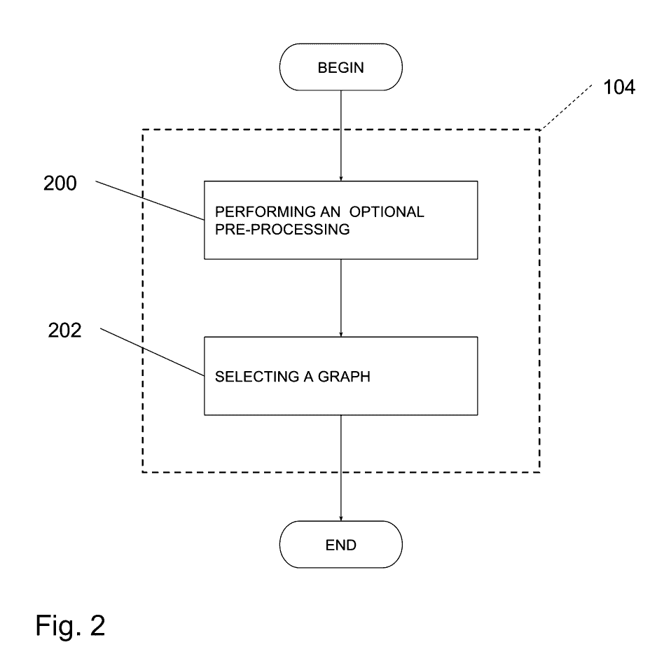

Now referring to FIG. 2, there is shown an embodiment for selecting a graph of the product of graphs.

According to processing step 200, an optional pre-processing is performed. It will be appreciated that the optional pre-processing is based on at least one of the size and the structure of the first graph G₁ and the second graph G₂.

More precisely, depending on the size and the densities of the graphs G₁ and G₂, graphs H₁ and H₂ may be determined.

In such case, it will be appreciated that the determined graph H₁ contains G₁ as a spanning subgraph while the determined graph H₂ contains G₂ as a spanning subgraph.

In fact, it will be appreciated that the determined graphs H₁ and H₂ are graphs with a simpler structure compared to the graphs G₁ and G₂, and are therefore easier to embed into the target graph, which is of great advantage. As a matter of fact, it will be appreciated that the determined graphs H₁ and H₂ are determined by selecting a more convenient graph to embed systematically than the graphs G₁ and G₂ due to their structure. The skilled addressee will appreciate that in one simple embodiment, the determined graphs H₁ and H₂ may be complete graphs which on Chimera have known systematic embedding called triangular embedding (see “Minor-embedding in adiabatic quantum computation: II. Minor-universal graph design,” V. Choi, Quantum Information Processing 10, 343 (2010)).

According to processing step 202, a graph is selected. It will be appreciated that, in the case where the optional pre-processing is performed, the graph selected is one of the determined graphs H₁ and H₂. In the case wherein the optional pre-processing is not performed, the graph selected is one of the graphs G₁ and G₂. In the following, it will be assumed that the optional pre-processing is performed.

In one embodiment, the graph is selected based on at least one parameter selected from a group consisting of a size of the determined graphs H₁ and H₂, a density of the determined graphs H₁ and H₂ and adjacency properties of the target graph.

As explained further below, it will be appreciated that the selected graph is embedded into a nexus and the other, non-selected, graph is embedded by establishing connections using the blocks of the target graph and the buses of the quadratic solver.

It will be appreciated that the method disclosed herein advantageously enables the use of the inherent repeated structure of the product of the determined graphs H₁□H₂ to design a two-step scalable embedding strategy.

As a matter of fact, the embedding problem is advantageously divided by first embedding one of the two determined graph, a simpler and smaller problem, into a repeatable unit which is defined as a nexus.

In the following, it is assumed that it is the first determined graph H₁, which is embedded in the nexus. In an alternative embodiment, the second determined graph H₂ is embedded in the nexus.

In order to embed the product of the determined graphs H₁□H₂, multiple copies of the determined graph H₁ are needed, wherein each set of corresponding nodes is connected such that they induce a subgraph isomorphic to the determined graph H₂.

It will be appreciated that the selection of the determined graph H₁ therefore reduces the original embedding problem to the placement of the instances of the nexus and the building of inter-nexus connections. As further explained below, this constitutes a second step of the procedure. The induced subgraph of the inter-nexus connections corresponds to multiple copies of the determined graph H₂, i.e., one for each variable of the determined graph H₁. The embedding problem is therefore framed as the placement of buses which extend the variables of the determined graph H₁ away from the instances of the nexus to a number of junctions, wherein individual variables are connected.

It will be appreciated that the quadratic solver architecture is assumed to have a fixed structure with limited connectivity between its registers. The quadratic solver architecture is characterized by a lattice of blocks, with each block being a logical grouping of a number of connected registers of the quadratic solver and the couplers connecting these registers. It will be appreciated that the structure is assumed to be regular and may be represented as various tilings of identical blocks. A tiling of repeated blocks is formally described by a lattice. The lattice directions are the vectors along which the blocks are reproduced. It will be appreciated by the skilled addressee that the high-level representation is not unique and is selected by the procedure described herein. A nexus is characterized by a mapping between variables of a graph to be embedded in the nexus and the registers of one or more than one adjacent blocks of the lattice occupied by the nexus. The nexus is further characterized by a set of terminals which provide connections to the corresponding assigned registers to the variables embedded in the nexus. The terminals are attachment points for the connecting buses to extend the variables of the nexus instances in order to reach junction blocks of the quadratic solver architecture where the connections of the variables of different nexus instances are made.

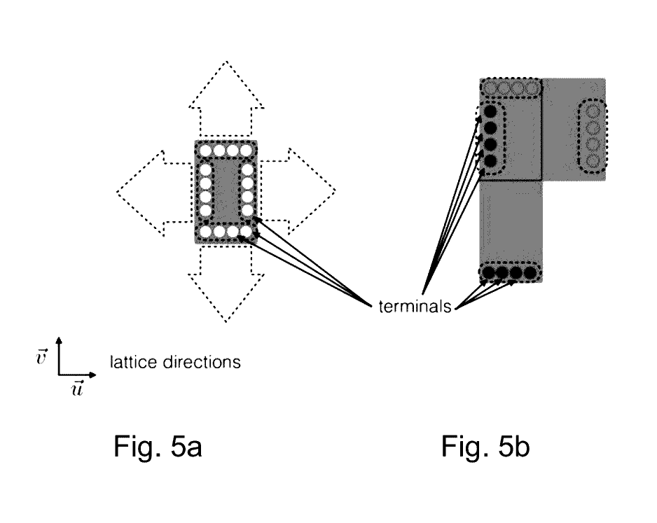

Now referring to FIG. 5a, there is shown an embodiment of a block with four (4) interfaces of four (4) terminals each. It will be appreciated that a block's interface is a collection of terminals along a certain lattice direction. It is a high-level representation for describing the edges between the nodes of two adjacent blocks.

In the embodiment shown in FIG. 5a, the dotted arrows indicate the outgoing connections to neighboring blocks for each interface.

It will be appreciated that given the quadratic solver architecture and description, the block's interface capacity can be inferred along a given direction as being the number of terminals of this interface. It corresponds exactly to the number of edges between two adjacent blocks.

Now referring to FIG. 5b, there is shown an embodiment of a nexus with two (2) interfaces for a subset of four (4) variables and two (2) interfaces with another subset of four (4) variables.

As mentioned previously, it will be appreciated that a nexus is defined as a repeatable pattern composed of one or more than one adjacent blocks which can host a copy of the determined graph H₁, in one embodiment, while respecting a set of terminal constraints.

The nexus interfaces specify the set of terminals the nexus provides to adjacent blocks on each of its faces, as well as which variables are assigned to those terminals. It will be appreciated that an interface can exist on each face of the nexus surface and should be thought of as attachment points for bus connections. Typically, variables will be partitioned into a fixed number of groups, which are referred to as variable subsets, and each individual interface is assigned to a given variable subset.

It will be appreciated that, in the target graph, this means that the subgraph composed of the nexus blocks can embed the determined graphs H₁ in such a way that each variable is accessible from the outside through an outgoing edge, as specified by the nexus interfaces and their terminals. It will be appreciated that a variable or node of the determined graphs H₁ can be assigned to multiple terminals belonging to different interfaces providing redundant access.

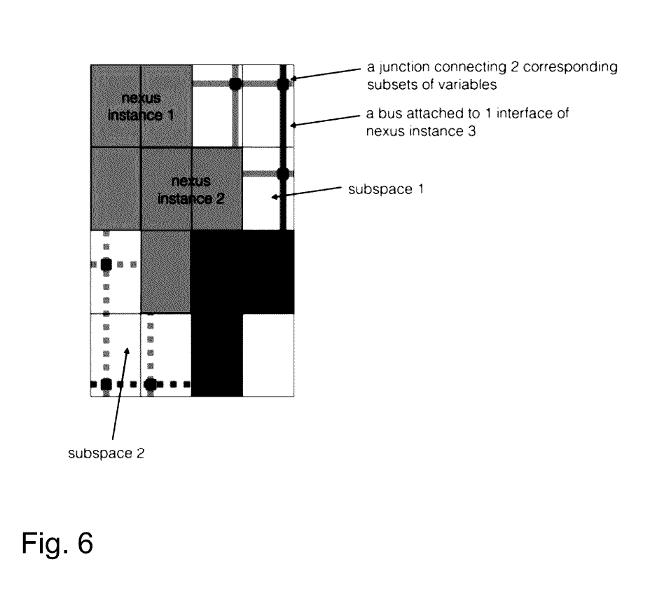

Now referring to FIG. 6, there is shown an embodiment of a quadratic solver architecture given by a 2D lattice of blocks. It will be appreciated that this figure shows a 4×4 lattice consisting of the sixteen (16) blocks shown in FIGS. 5a and 5b with an embedding pattern for a G₁□K₃ where copies of G₁ are embedded in a nexus instance. G₁ is an arbitrary graph and K₃ is a fully connected graph of size 3. The associated nexus instances and connecting buses are shown.

It will be appreciated that a nexus, such as for instance the nexus disclosed in FIG. 5b, defines a repeatable pattern, while the nexus instances are actual instances of that pattern. For instance, in FIG. 6, three (3) nexus instances of the nexus shown in FIG. 5b are shown.

Similarly, there are multiple copies of the determined graph H₁ in the Cartesian product H₁□H₂. It will be appreciated that each copy of the determined graph H₁ corresponds to a single nexus instance with its own distinct set of variables. The variables of the determined graph H₁ are referred to as the nexus variables, or simply the determined graph H₁ variables, while the variables associated to copies of the determined graph H₁ are the instance variables.

It will be further appreciated that a bus space is a set of the lattice blocks not occupied by any nexus. It will be appreciated that a block of the bus space can host a limited number of connecting buses depending on the underlying subgraph structure. A connecting bus going through a block links two block interfaces together. Restrictions exist on the number of connecting buses going through a block and their exact configuration due to the structure of the underlying target architecture graph. A bus subspace, or subspace, is referred to as a specific contiguous region of the bus space. It will be appreciated that each connecting bus is used for creating a connection between corresponding sets of terminals such that the connecting buses create a set of connections representative of the edges of the other graph.

Now referring to FIG. 6, it will be appreciated that two (2) subspaces are used to realize the needed connections. Dotted and solid lines represent connecting buses corresponding to disjoint subsets of variables. It will be appreciated that having two (2) subspaces is a direct consequence of the choice of embodiment in FIG. 6 and is not a general feature.

It will be appreciated that a connecting bus is a set of parallel paths leaving from a nexus interface, with one path per terminal. It will be appreciated that each path is therefore assigned to a specific variable. The blocks of the bus space traversed by a connecting bus are called the host blocks of the connecting bus. Two connecting buses can be linked together at a bus junction.

A bus junction is defined as any attachment between two connecting buses meeting at one block of the bus space.

For example, let H₁=K₈ and H₂=K_{N-1} for a Chimera with the corresponding lattice built out of N unit cells in each direction. Then the determined graph H₁ is embedded locally using a nexus, and the determined graph H₂ is embedded using connecting buses.

Now referring back to FIG. 1 and according to processing step 106, a nexus is determined for embedding the selected graph of the product of graphs representative of the input problem in the architecture of the quadratic solver.

It will be appreciated that the nexus is determined using the processing device 700 in accordance with one embodiment.

It will be appreciated that in the case where the optional pre-processing step is performed, the selected graph is one of the determined graphs H₁ and H₂.

It will be appreciated that the determined nexus comprises one or more than one adjacent blocks. The determined nexus further provides a mapping of the corresponding selected graph variables of the selected graph to corresponding assigned registers of the determined nexus. The determined nexus further comprises a set of terminals for providing a connection to the corresponding assigned registers of the nexus.

According to processing step 108, a pattern of more than one of the determined nexus and corresponding connecting buses is determined using the other graph of the product of graphs to generate for the nexus and buses to generate an embedding pattern. Each connecting bus is used for creating a connection between corresponding sets of terminals such that the connecting buses create a set of connections representative of the plurality of edges of the other graph. It will be appreciated that, in some cases, it is advantageous to impose restrictions on the nexus instances disposition and the connecting bus pattern to achieve specific properties on the resulting embedding pattern. An example of that would be to limit the size of the connecting buses to control the length of chains in the final embedding.

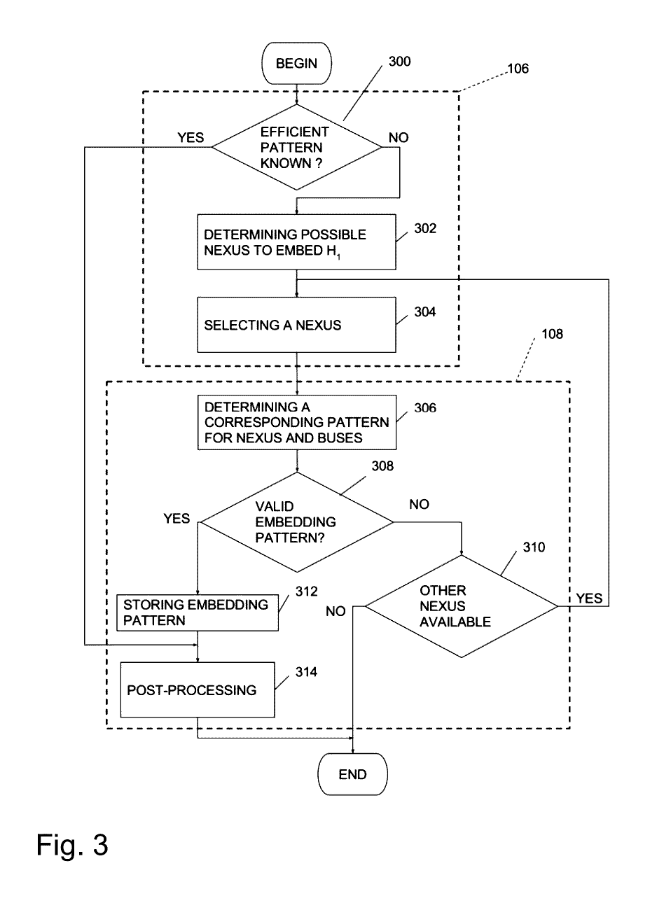

Now referring to FIG. 3, there is shown an embodiment for determining a nexus for embedding the selected graph and for determining a pattern of more than one of the determined nexus and corresponding connecting buses.

According to processing step 300, a test is performed in order to find out if an efficient embedding pattern is known.

In fact, it will be appreciated that various problems which share a similar structure might produce the same choice of determined graphs H₁ and H₂. In accordance with an embodiment, a database of previously found embedding patterns may therefore be accessed using the properties of the determined graphs H₁ and H₂. In one embodiment, the database of previously found embedding patterns, not shown, is located in the memory unit 712 of the processing device 700. In an alternative embodiment, the database of previously found embedding patterns is located in a remote processing device, not shown, operatively coupled to the processing device 700. It will be appreciated that the remote processing device may be operatively coupled to the processing device 700 according to various embodiments. In one embodiment, the remote processing device is operatively coupled to the processing device 700 using a data network, not shown.

It will be appreciated that such database of previously found embedding patterns may be advantageously used to speed up the process of finding embedding patterns by relying on the results of previous successful embedding trials.

In the case where no embedding pattern is known and according to processing step 302, a plurality of potential nexus for embedding the determined graph H₁ are determined.

It will be appreciated by the skilled addressee that the problem of finding a nexus is a smaller embedding problem than the original problem of embedding the input graph. Also, it will be appreciated that various embedding methods may be applied to embed the determined graph H₁ in a nexus. A key difference is the requirement for bus interfaces. In one embodiment where the target graph is Chimera, and the determined graph H₁ is a complete graph, finding the nexus may be done by triangular embedding (see “Minor-embedding in adiabatic quantum computation: II. Minor-universal graph design,” V. Choi, Quantum Information Processing 10, 343 (2010)).

It will be appreciated by the skilled addressee that the determining of the list of a plurality of potential nexus for embedding the determined graph H₁ constitutes a much smaller embedding problem than the original one.

It will be further appreciated that the identification of valid nexus for the input problem may be based on various data, including, but not limited to, the quadratic solver architecture, the chosen description of the quadratic solver architecture, a structure of the determined graph H₁, previous nexus found and stored for future use, previous desirable embedding patterns and bus configurations, etc.

It will be appreciated that a valid nexus has to correspond to a subgraph of the target graph that can embed a copy of the determined graph H₁ while providing a sufficient number of interfaces to access all variables of the determined graph H₁. Requirements for the number of redundant interfaces and their distributions among the available lattice directions are imposed by the quadratic solver architecture description (e.g., taking into account the block capacity).

Still referring to FIG. 3 and according to processing step 304, a nexus is selected.

It will be appreciated that the nexus is selected using the processing device 702.

It will be appreciated that the nexus is selected amongst the possible nexus to embed the determined graph H₁.

It will be appreciated that the nexus is selected among the list of a plurality of potential nexus for embedding the determined graph H₁.

It will be appreciated that it is desirable to have a nexus as small as possible while still providing a sufficient number of redundant interfaces.

In fact, it will be appreciated by the skilled addressee that the scalability of the resulting embedding pattern is greatly affected by the choice of a nexus. As a matter of fact, it will be appreciated that a nexus that can be compactly tiled facilitates achieving a near-optimal embedding pattern.

It will be further appreciated that the nexus choice also specifies how the nexus interconnects with its neighbors. The set of variables of the determined graph H₁ is partitioned into subsets of variables. Each subset of variables is assigned a number of redundant interfaces available for building the inter-nexus connections. An interface is therefore a set of connection points, called terminals, corresponding to the variables of the subset and placed on a specific face of the nexus. A connecting bus connects to an interface and extends the set of associated instance variables.

According to processing step 306, a corresponding pattern for nexus and buses is determined.

In one embodiment, a pattern of more than one of the determined nexus and corresponding connecting buses is determined using the processing device 700.

It will be appreciated that the determination of an embedding pattern is an optimization problem with many fewer degrees of freedom than the original embedding problem. It is further appreciated that various numerical methods may be used to solve that problem. A corresponding solver for determining the embedding pattern can be referred to as a location optimizer. In one embodiment, the location optimizer comprises a systematic algorithm. In another alternative embodiment, the location optimizer comprises an heuristic algorithm (e.g., a simulated annealing search or a tabu search, etc.)

It will be appreciated that locating the nexus instances on the lattice may divide the bus space into disjoint subspaces. Since only corresponding instance variables need to be connected according to the determined graph H₂, these disjoint subspaces are sufficient to establish connections between subsets of corresponding instance variables. This is the motivation behind dividing the instance variables into disjoint subsets. Once divided, the variables in all nexus instances can be permutated so that all corresponding subsets of instance variables have interfaces toward the same subspace on the lattice. In this way, a subspace is used to realize all of the graph H₂ connections within the corresponding variable subset. It will be appreciated that a desired embedding pattern for H₁□H₂ will be achieved provided that the nexus instances are arranged so that enough subspaces are obtained to cover all instance variables.

In fact, it will be appreciated that a number of general constraints on the placement of nexus instances can be derived.

Firstly, each nexus instance has to be adjacent to all defined subspaces. Furthermore, none of the nexus instances should block a required interface of another nexus instance. Additionally, each subspace should be large enough to satisfy all of the determined graph H₂ connections.

It will be appreciated that a specialized location optimizer may be used to optimize the placement of the nexus instances and the structure of the subspaces. Various embodiments for this location optimizer may be used. However, for specific quadratic solver architectures, the procedure admits systematic solutions to the problem of locating nexus instances without necessarily resorting to a location optimizer. The skilled addressee will appreciate that a location optimizer is a specialized solver whose task is to seek an optimal embedding pattern. Given the set of instances of the nexus, the location optimizer chooses the appropriate buses for connecting them. It will be appreciated that desired features may be specified, such as constraints on the bus length or scalability of the embedding pattern.

One embodiment of the quadratic solver architecture wherein the target graph is described by a 2D square lattice of blocks admits an effective and systematic layout of the embedding pattern elements. The lattice directions may be referred to as vertical and horizontal. The choice of a specific nexus for a problem will depend not only on the problem at hand, but also, critically, on the quadratic solver architecture, i.e., the target graph.

It will be appreciated that in the case of a 2D lattice, a near-optimal choice is to position the nexus instances along the diagonal of the lattice with two triangular subspaces on each side. Such placement of the nexus instances conveniently provides at least two free interfaces facing each of the two subspaces for each nexus instance. Without loss of generality, these subspaces can be referred to as the upper and lower triangular subspaces.

With each nexus instance having two interfaces facing one of the triangular subspaces, a subset of instance variables can be extended by attaching a linear connecting bus to the corresponding interface, excluding interfaces lying on the lattice boundaries. Each pair of nexus interfaces may therefore be connected at a single junction. This realizes all required d H₂ connections on that subspace. The same arrangement can be implemented in the other triangular subspace. A valid embedding for H₁□H₂ is thereby achieved on the 2D lattice.

It will be further appreciated that the number of nexus instances needed is prescribed by the number of nodes in the determined graph H₂. Since the determined graph H₂ can be assumed to be a complete graph, it is also pertinent to ensure a one-to-one connectivity between the corresponding variables of each nexus instance. A connecting bus can only connect a number of variables that does not exceed the interface capacity of a block. The problem of placing the nexus on the lattice and laying out required buses to connect their interface together is a higher-level and simpler problem than the underlying embedding problem, and may be delegated to a specialized location optimizer.

According to processing step 308, a test is performed in order to find out if a valid embedding pattern has been found.

It will be appreciated that this processing step is used for checking that a valid pattern was found by establishing that H₁□H₂ is correctly embedded into the target graph.

The skilled addressee will appreciate that validating a proposed embedding pattern is trivial. Each variable of the input problem needs to be assigned to an adjacent set of nodes of the target graph such that the adjacency matrix of the input graph can be realized on the target architecture. In one embodiment, the test is performed using the processing device 700.

In the case where a valid embedding pattern has been found and according to processing step 312, the embedding pattern is stored.

In one embodiment, the embedding pattern is stored in the memory unit 712 of the processing device 700. In an alternative embodiment, the embedding pattern is stored in a remote processing unit operatively connected to the processing device 700.

If the embedding pattern is easily scalable with the size of the determined graph H₂, a specification for the generalization of the embedding pattern is produced along with parametrized requirements for the quadratic solver architecture.

It will be appreciated that the indication of the embedding pattern and the scalable pattern, if applicable, are stored in a database for future reference.

It will be appreciated that a scalable pattern is a mapping and can be saved in various forms and different database format.

In the case where no valid embedding pattern has been found, and according to processing step 310, a test is performed in order to find out if at least one other suitable nexus is available.

In the case where no other suitable nexus exists, suggestions on resources needed, e.g., minimum size of the target graph to accommodate the requested Cartesian product, etc., may be provided. In one embodiment, the suggestions are provided using previously stored embedding patterns for larger target architectures and Cartesian products that contain the current input graph as a subgraph. In an alternative embodiment, a scalable embedding pattern relevant for the current input problem may be used to extrapolate the size needed and provide the suggestions. The suggestions may alternatively be obtained by performing the whole embedding pattern search again for a larger target graph, i.e., one with the same block but a larger or infinite lattice.

In the case where at least one other suitable nexus is available, and according to processing step 304, a suitable nexus amongst the at least one other nexus is selected.

According to processing step 314, a post-processing is performed.

Now referring back to FIG. 1 and according to processing step 110, an indication of the embedding pattern is provided.

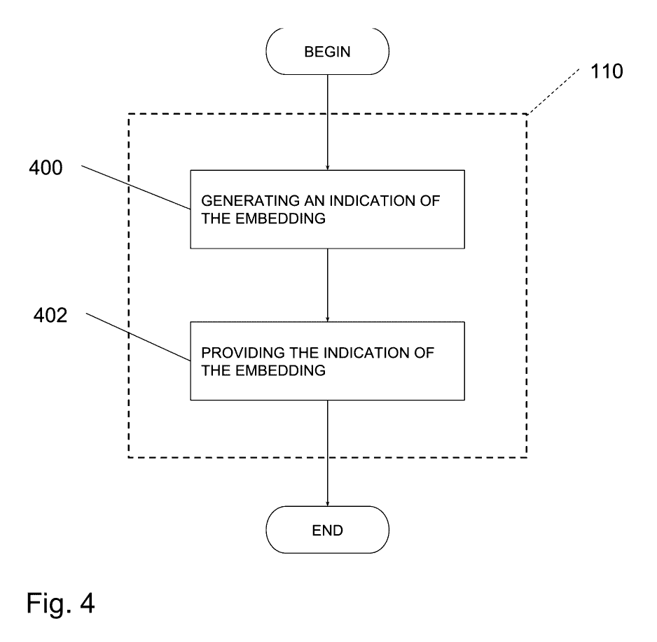

Now referring to FIG. 4, there is shown an embodiment for providing an indication of the embedding pattern.

According to processing step 400, an indication of an embedding is generated.

It will be appreciated that the embedding pattern is a high-level description of the embedding for H₁□H₂.

In one embodiment, before converting the solution found to the specific input problem, an optional post-processing is performed. It will be appreciated that the optional post-processing performed is intended to fine-tune the embedding for the problem and solver at hand. The optional post-processing may depend on a problem being solved, the quadratic solver architecture, the choice for the product of graphs, etc.

It will be further appreciated that the post-processing may include, but is not limited to, unused-variable pruning, corrections due to faulty registers, etc. In one embodiment, the corrections for faulty registers is done by deforming and shifting nexus instances using simple operations that can be derived based on target architecture and its symmetries.

According to processing step 402, the indication of the embedding is provided.

In one embodiment, the indication of the embedding for the input problem is provided to the user interacting with the processing device 700.

In an alternative embodiment, the providing of the indication of the embedding for the input problem comprises at least one of storing the indication of the embedding for the input problem in the memory unit 712 of the processing device 700 and storing the indication of the embedding for the input problem in a remote processing device operatively connected to the processing device 700.

In an alternative embodiment, the indication of the embedding for the input problem is provided to the quadratic solver. The indication of the embedding may be provided to the quadratic solver according to various embodiments.

In such embodiment, the quadratic binary optimization problem is then solved using the quadratic solver. The method for solving the quadratic binary optimization problem therefore comprises generating the embedding pattern used for solving the quadratic binary optimization problem using the quadratic solver using the method disclosed herein and solving the quadratic binary optimization problem using the embedding pattern generated.

It will be appreciated that, in the embodiments disclosed above, it is assumed that the quadratic solver architecture is completely regular. A corollary is that the quadratic solver architecture does not have defects which break the regularity. In various alternative embodiments, it is possible to adapt the method disclosed herein to tolerate some level of irregularity as explained further below.

In the following, irregularities are therefore considered in the quadratic solver architecture.

It will be appreciated that the irregularities may be introduced in the quadratic solver architecture when registers in the associated hardware embodiment are considered inoperable. Similarly, inoperable couplers between registers can break the regularity of the quadratic solver architecture.

In the simplest embodiment, such inoperable registers and couplers are ignored until the post-processing step 314 shown in FIG. 3. In such case, the method carries through mostly unchanged, assuming a fully working quadratic solver architecture until the post-processing removes the inoperable components from the embedding pattern.

It will be appreciated that a number of steps may be modified in order to increase the chance of success of finding a valid embedding pattern for a given input problem despite the presence of inoperable components.

These steps may include, but are not limited to, selecting the determined graph H₁ in processing step 104, selecting a nexus in processing step 106, and determining a corresponding embedding pattern in processing step 108.

In one embodiment, a modification to the processing step 104 may involve selecting a larger determined graph H₁, that is, a graph with more nodes than the graph G₁, in order to allow for losses due to irregularities in the post-processing step.

Each nexus instance may also be modified to route around nexus-internal faults. Equivalently, the exact nexus and bus configuration may be selected while taking the inoperable registers into consideration. In one embodiment this amounts to having a more complex location optimizer which may route the buses and shift the nexus instances positions in order to bypass inoperable components.

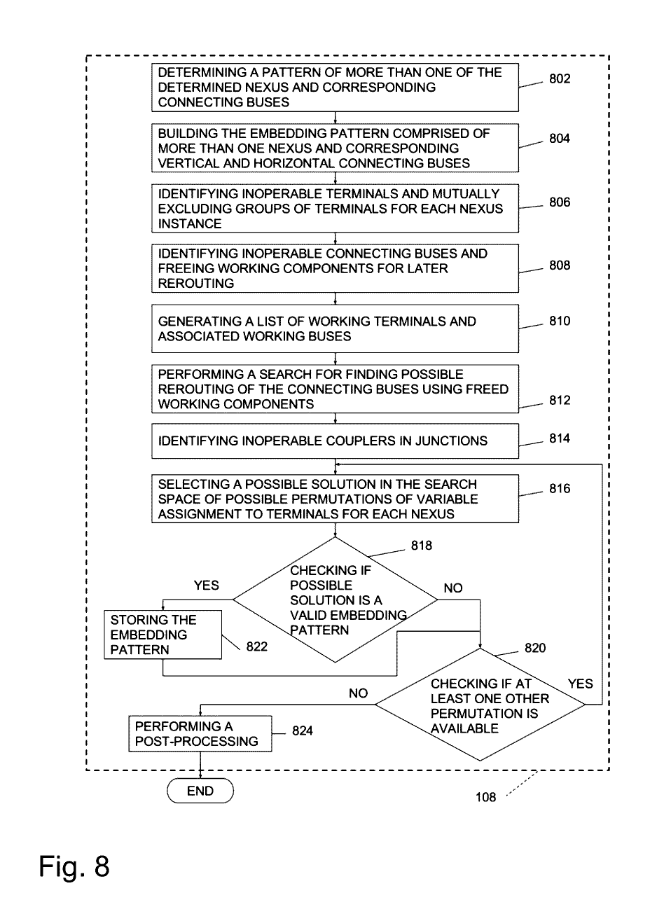

Now referring to FIG. 8, there is shown an embodiment for determining a pattern of more than one of the determined nexus and corresponding connecting buses when irregularities are present in the quadratic solver architecture.

According to processing step 802, a pattern of more than one of the determined nexus and corresponding connecting buses is determined. It will be appreciated that, in this case, the location optimizer is used assuming an ideal quadratic solver architecture. It will be therefore understood that this means assuming inoperable components are fully working, not removing them at this point.

According to processing step 804, vertical and horizontal connecting buses are built and the location of the nexus instances is chosen.

According to processing step 806, inoperable terminals and mutually excluding groups of terminals for each nexus instance are identified.

It will be appreciated that inoperable components are now considered and chains of registers inside each nexus instance are verified for the presence of inoperable components. In one embodiment, it is assumed that the quadratic solver architecture includes the information of which components are inoperable or that a user specifies them as input. Given these, the mapping representative of the embedding pattern is checked for use of inoperable components.

It will be appreciated that if one chain of registers relies on an inoperable component, the at least one corresponding terminal is marked as inoperable. In some cases, a required component or a plurality of components can lead to a group of mutually exclusive terminals. In one embodiment, an inoperable coupler needed to connect two chains of registers within a nexus instance may be inoperable. In such case, one of the two chains of registers may be used and still lead to a valid embedding provided the other chain of registers is not used. In such case, a choice between the two chains of registers exists and is identified through a set of mutually exclusive terminals.

According to processing step 808, inoperable connecting buses are identified and groups of terminals are mutually excluded for each nexus instance. In fact, inoperable components within the connecting buses are now identified and the resulting inoperable connecting buses are marked as such. The working components, i.e., the working registers and couplers, of the inoperable connecting bus are freed for possible reassignment in processing step 812. It will be appreciated that the building of nexus and buses involves building a mapping of variables to registers. Unused or unassigned registers are considered free. It will be therefore appreciated that freeing registers according to their state of operability is as simple as modifying the mapping.

According to processing step 810, a list of working terminals and associated connecting buses is generated. It will be appreciated by the skilled addressee that a working terminal or connecting bus is one that has not been marked as inoperable.

According to processing step 812, a search is performed for finding a possible rerouting of the connecting buses using the freed working components identified in processing step 808. It will be appreciated that the objective of this processing step to increase the list of at least one working terminal and at least one connecting bus. The skilled addressee will appreciate that various search methods or optimization procedures may be used in this processing step. In one embodiment, a multi-commodity flow solver is used to connect terminals that are working to the junctions required by the embedding pattern while avoiding inoperable components. The skilled addressee will appreciate that the multi-commodity flow problem is a well know problem which can be solved with various known methods.

According to processing step 814, inoperable couplers are identified within the junction blocks. It will be appreciated by the skilled addressee that these inoperable couplers in the junction blocks might or might not be needed in the final embedding pattern depending on the chosen permutation of the variable assignment for each nexus instance.

It will be appreciated that the previous processing steps have formulated a search space for the next step of the location optimizer wherein a permutation of logical variables has to be determined on each of the nexus instances and their associated interfaces.

The permutation of the logical variables needs to take into account the groups of mutually exclusive terminals to generate valid embedding patterns. The division into bus subspaces, the presence of inoperable couplers in the junction blocks, etc., also supply extra constraints for the selection. The skilled addressee will appreciate that the resulting search space may be explored using various search methods or optimization algorithms. In one embodiment the search method used is a simple greedy heuristic method.

Still referring to FIG. 8 and according to processing step 816, a possible solution is selected. It will be appreciated that different solutions in that search space will result in an embedding pattern for different sizes of Cartesian products.

Still referring to FIG. 8 and according to processing step 818, a check is performed in order to find out if the chosen solution is a valid embedding pattern.

In the case where the chosen solution is a valid embedding pattern and, according to processing step 822, the embedding pattern is stored. In one embodiment, the embedding pattern is stored in the memory unit 712 of the processing device 700. In an alternative embodiment, the embedding pattern is stored in a remote processing device operatively connected to the processing device 700.

In the case where the chosen solution is not valid and according to processing step 820, a check is performed in order to find out if there is at least one other permutation available. In the case where there is at least one other permutation available and according to processing step 816, a possible solution is chosen.

In the case where no other permutation is available and according to processing step 824, a post-processing is performed.

It will be appreciated that in a different embodiment, inoperable components within a nexus instance may be circumvented through the use of an embedding heuristic.

By choosing a larger nexus shape to provide some margin to account for irregularities and by imposing terminal constraints, a general purpose embedder may be used to solve the smaller problem of embedding a specific nexus instance that avoids the inoperable components within that instance. It will be appreciated that the rest of the method described in FIG. 8 may then be applied to circumvent inoperable components in the bus space.

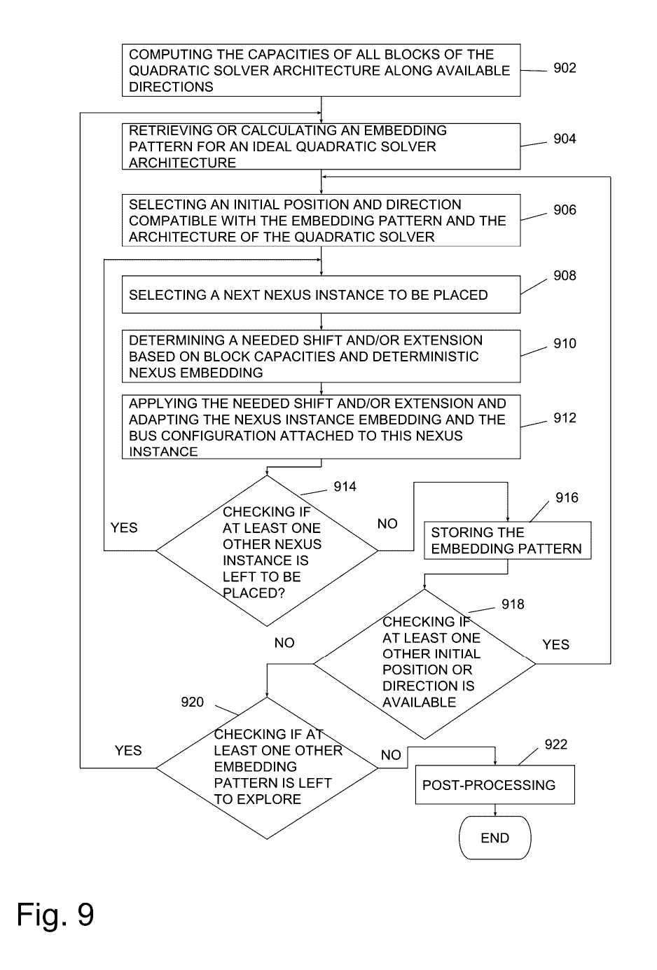

Now referring to FIG. 9, there is shown another embodiment of the method for generating an embedding pattern for the case of a quadratic solver architecture which includes inoperable components.

A systematic embedding, such as the triangular embedding, is assumed for the nexus. It will be appreciated by the skilled addressee that the method described remains relevant if another embedding method is used for the nexus.

According to processing step 902, the capacities of all blocks of the quadratic solver architecture along the available directions are computed.

In one embodiment, the capacities to all blocks of the quadratic solver architecture along the available directions are computed using the processing device 700.

According to processing step 904, an indication of an embedding pattern for the same quadratic solver architecture without inoperable components is obtained.

It will be appreciated by a skilled addressee that the quadratic solver architecture may have a number of symmetries allowing the same embedding pattern to be used in various ways. For instance, and in one embodiment, an embedding pattern on a quadratic solver architecture with 90-degree step rotational symmetry and describing a placement of nexus along a diagonal may be valid along the other diagonals by starting from a different corner. In another embodiment, a small embedding pattern on a regular target graph with translational symmetry may be placed in different locations of the same quadratic solver architecture.

According to processing step 906, an initial position and direction compatible with the embedding pattern and the quadratic solver architecture is selected.

According to processing step 908, a next nexus instance to be placed is selected.

According to processing step 910, and based on the current position, a needed shift and/or extension for a nexus is determined. It will be appreciated that in one embodiment wherein a simple deterministic embedding is used for the nexus instance, this decision is a simple deterministic decision based on: 1—the block capacities along the connecting buses attached to the current nexus instance being placed; 2—the embedding of the nexus instance; and 3—the presence of inoperable components within the nexus. It will be appreciated that in this embodiment, the connecting buses are always assumed to run from their interface to the edge of the quadratic solver architecture to allow for connection with all nexus instances to be placed.

According to processing step 912, a needed shift and/or extension is applied to the nexus instance position. The embedding of the nexus instance is adapted to avoid inoperable components and the new position for further nexus placement is updated.

According to processing step 914, a test is performed in order to find out if at least one other nexus instance is left to be placed.

In the case where no other nexus instance is left to be placed and according to processing step 916, an indication of the resulting embedding pattern is stored.

It will be appreciated that the indication of the resulting embedding pattern may be stored according to various embodiments.

In accordance with one embodiment, the indication of the resulting embedding pattern is stored in the memory unit 712 of the processing device 700. In an alternative embodiment, the indication of the resulting embedding pattern is stored in a remote processing device operatively connected with the processing device 700.

According to processing step 918, a test is performed in order to find out if a combination of a direction and an initial position is available. In the case where there is a combination of a direction and an initial position available and according to processing step 906, a combination of a direction and an initial position is selected for building the embedding pattern.

In the case where there is not a combination of a direction and an initial position available and according to processing step 920, a test is performed in order to find out if there is at least one other embedding pattern to explore.

In the case where there is at least one other embedding pattern to explore and according to processing step 904, an embedding pattern is selected.

In the case where there is not at least one other embedding pattern to explore and according to processing step 922, a post-processing is performed.

It will be appreciated that the post-processing may comprise, but is not limited to, unused-variable pruning, register chains shortening when possible, etc.

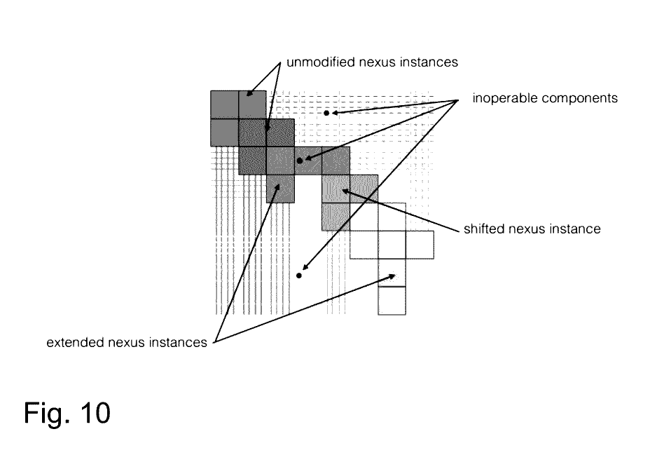

Now referring to FIG. 10, there is shown an embodiment of an embedding pattern produced using the method disclosed in FIG. 9 for the case of the embedding pattern presented in FIG. 6, but in presence of a few inoperable components. The nexus used is the same as presented in FIG. 5b.

Now referring back to FIG. 7, it will be appreciated that the memory unit 712 further comprises an application for generating an embedding pattern used for solving a quadratic binary optimization problem using a quadratic solver 716.

The memory unit 712 may further comprise data 718 used by the application for generating an embedding pattern used for solving a quadratic binary optimization problem using a quadratic solver 716. It will be appreciated that the quadratic solver is characterized by an architecture comprising a plurality of blocks, each block comprising a plurality of registers.

In one embodiment, the application for generating an embedding pattern used for solving a quadratic binary optimization problem using a quadratic solver 716 comprises instructions for obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem.

The application for generating an embedding pattern used for solving a quadratic binary optimization problem using a quadratic solver 716 further comprises instructions for decomposing the quadratic binary optimization problem into a product of graphs representative of the input problem.

The application for generating an embedding pattern used for solving a quadratic binary optimization problem using a quadratic solver 716 further comprises instructions for selecting a graph of the product of graphs representative of the quadratic binary optimization problem, the selected graph having corresponding selected graph variables; the other graph having a plurality of edges.

The application for generating an embedding pattern used for solving a quadratic binary optimization problem using a quadratic solver 716 further comprises instructions for determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus.

The application for generating an embedding pattern used for solving a quadratic binary optimization problem using a quadratic solver 716 further comprises instructions for determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph.

The application for generating an embedding pattern used for solving a quadratic binary optimization problem using a quadratic solver 716 further comprises instructions for providing an indication of the embedding pattern.

It will be appreciated that, alternatively, a virtual computer on a cloud computing platform running on a large-scale server or computer cluster may be used.

It will be also appreciated that there is also disclosed a non-transitory computer-readable storage medium. The non-transitory computer-readable storage medium is used for storing computer-executable instructions which, when executed, cause a processing device to perform a method for generating an embedding pattern used for solving a quadratic binary optimization problem using a quadratic solver characterized by an architecture comprising a plurality of blocks, each block comprising a plurality of registers, the method comprising obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem; decomposing the quadratic binary optimization problem into a product of graphs representative of the input problem; selecting a graph of the product of graphs representative of the quadratic binary optimization problem, the selected graph having corresponding selected graph variables; the other graph having a plurality of edges; determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus; determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph and providing an indication of the embedding pattern.

An advantage of the method for generating an embedding pattern disclosed herein is that it improves the solving of graph optimization problems on quadratic solvers having a lattice-like structure. In particular, an advantage of the method for generating an embedding pattern disclosed herein is that fewer registers may be required to solve the optimization problem on the quadratic solver.

Another advantage of the method for generating an embedding pattern disclosed herein is that a better distribution of chain lengths may also be achieved.

Another advantage of the method for generating an embedding pattern disclosed herein is that larger problems may also be embedded in a faster embedding time.

Another advantage of the method for generating an embedding pattern disclosed herein that a higher success rate may be obtained compared to prior art available heuristic methods for generating an embedding pattern.

Although the above description relates to a specific preferred embodiment as presently contemplated by the inventor, it will be understood that the invention in its broad aspect includes functional equivalents of the elements described herein.

1. A method for generating an embedding pattern used for solving a quadratic binary optimization problem using a quadratic solver characterized by an architecture comprising a plurality of blocks, each block comprising a plurality of registers, the method comprising:
use of a processing device for:
obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem;
decomposing the quadratic binary optimization problem into a product of graphs representative of the input problem;
selecting a graph of the product of graphs representative of the quadratic binary optimization problem, the selected graph having corresponding selected graph variables; the other graph having a plurality of edges;
determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus;
determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph; and
providing an indication of the embedding pattern.

2. The method as claimed in claim 1, wherein the indication of a quadratic binary optimization problem is obtained from one of a user interacting with the processing device, a memory located in the processing device and a remote processing device operatively connected to the processing device.

3. The method as claimed in claim 1, wherein the decomposing of the quadratic binary optimization problem into a product of graphs representative of the input problem quadratic binary optimization problem comprises determining a first graph G₁ and a second graph G₂ such that the graph G is a spanning subgraph of G₁□G₂.

4. The method as claimed in claim 3, wherein the selecting of a graph of the product of graphs representative of the quadratic binary optimization problem comprises determining graphs H₁ and H₂ such that the determined graphs H₁ and H₂ contain G₁ and G₂ as spanning subgraphs respectively; further wherein the graph selected is one of the determined graphs H₁ and H₂.

5. The method as claimed in claim 4, wherein the graph is selected based on at least one parameter selected from a group consisting of a size of the determined graphs H₁ and H₂, a density of the determined graphs H₁ and H₂, and adjacency properties of the architecture characterizing the quadratic solver.

6. The method as claimed in claim 1, wherein the indication of the embedding pattern is provided to a user interacting with the processing device.

7. The method as claimed in claim 1, wherein the providing of the indication of the embedding pattern comprises performing at least one of storing the indication of the embedding pattern in a memory located in the processing device and providing the indication of the embedding pattern to a remote processing device operatively connected to the processing device.

8. The method as claimed in claim 1, wherein the embedding pattern is provided to the quadratic solver.

9. The method as claimed in 1, further comprising:
obtaining an indication of at least one inoperable component in the architecture of the quadratic solver;
performing at least one of:
removing the at least one inoperable component from the embedding pattern to produce a smaller valid embedding pattern;
rerouting at least one connecting bus around the at least one inoperable component;
modifying each nexus instance to avoid the at least one inoperable component;
selecting a nexus embedding for each instances while preserving the same interface to avoid the at least one inoperable components; and
permuting an assignment of variable on each nexus instance to avoid the at least one inoperable component.

10. A method for solving a quadratic binary optimization problem using a quadratic solver, the method comprising:
generating an embedding pattern used for solving the quadratic binary optimization problem using the quadratic solver according to claim 1; and
solving the quadratic binary optimization problem using the embedding pattern generated.

11. A processing device for generating an embedding pattern used for solving a quadratic binary optimization problem using a quadratic solver, the processing device comprising:
a central processing unit;
a display device;
a communication port for operatively connecting the processing device to a quadratic solver characterized by an architecture comprising a plurality of blocks, each block comprising a plurality of registers;
a memory unit comprising an application for generating an embedding pattern used for solving a quadratic binary optimization problem, the application comprising:
instructions for obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem;
instructions for decomposing the quadratic binary optimization problem into a product of graphs representative of the input problem;
instructions for selecting a graph of the product of graphs representative of the quadratic binary optimization problem, the selected graph having corresponding selected graph variables; the other graph having a plurality of edges;
instructions for determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus;
instructions for determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph;
instructions for providing an indication of the embedding pattern; and
a data bus for interconnecting the central processing unit, the display device, the communication port and the memory unit.

12. A non-transitory computer-readable storage medium for storing computer-executable instructions which, when executed, cause a processing device to perform a method for generating an embedding pattern used for solving a quadratic binary optimization problem using a quadratic solver characterized by an architecture comprising a plurality of blocks, each block comprising a plurality of registers, the method comprising:
obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem;
decomposing the quadratic binary optimization problem into a product of graphs representative of the input problem;
selecting a graph of the product of graphs representative of the quadratic binary optimization problem, the selected graph having corresponding selected graph variables; the other graph having a plurality of edges;
determining a nexus for embedding the selected graph of the product of graphs representative of the input problem in the architecture of the quadratic solver; wherein the determined nexus comprises one or more than one adjacent blocks; further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus;
determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph; and
providing an indication of the embedding pattern.

13. A method for generating an embedding pattern used for solving a quadratic binary optimization problem using a quadratic solver characterized by an architecture comprising a plurality of blocks, each block comprising a plurality of registers, the method comprising:
obtaining an indication of a quadratic binary optimization problem representative of an input problem to solve using the quadratic solver; wherein the quadratic binary optimization problem is defined as a graph G=(V,E) comprising a set of nodes V representing variables of the input problem and corresponding edges E representing terms of the input problem;
decomposing the quadratic binary optimization problem into a product of graphs representative of the input problem;
selecting a graph of the product of graphs representative of the quadratic binary optimization problem, the selected graph having corresponding selected graph variables; the other graph having a plurality of edges;
determining a nexus for embedding the selected graph of the product of graphs representative of the input problem in the architecture of the quadratic solver;
wherein the determined nexus comprises one or more than one adjacent blocks;
further wherein the determined nexus provides a mapping of the corresponding selected graph variables of the selected graph to corresponding assigned registers of the determined nexus; further wherein the determined nexus comprises a set of terminals for providing a connection to the corresponding assigned registers of the nexus;
determining a pattern of more than one of the determined nexus and corresponding connecting buses using the other graph of the product of graphs to generate an embedding pattern; wherein each connecting bus is used for creating a connection between corresponding sets of terminals such that the connecting buses create a set of connections representative of the plurality of edges of the other graph; and
providing an indication of the embedding pattern.

14. A method for generating an embedding pattern used for solving a quadratic binary optimization problem using a quadratic solver characterized by an architecture, the method comprising:
obtaining an indication of a quadratic binary optimization problem representative of an input problem to solve using the quadratic solver;
decomposing the quadratic binary optimization problem into a product of graphs representative of the input problem;
selecting a graph of the product of graphs representative of the quadratic binary optimization problem;
determining a nexus for embedding the selected graph of the product of graphs representative of the input problem in the architecture of the quadratic solver;
determining a corresponding pattern for the nexus and buses to generate an embedding pattern using another graph of the product of graphs; and
providing an indication of the embedding pattern.

15. The method as claimed in claim 1, wherein the quadratic binary optimization problem is decomposed into a product of more than two graphs representative of the input problem; further wherein the graph selected is comprised of one selected graph or a product of more than one selected graph of the product of more than two graphs; further wherein the other graph used for determining the pattern of more than one of the determined nexus and corresponding connecting buses is comprised of a non-selected graph or a product of all the more than one non-selected graphs of the product of more than two graphs.
